(19) United States
(12) Patent Application Publication
(10) Pub. No.: US 2006/0294575 A1
(43) Pub. Date: Dec. 28, 2006

(54) Method and apparatus for use in security

(76) Inventor: Paul Jason Rogers, Belfast (GB)

Correspondence Address: Eric M Gayan;STANDLEY LAW GROUP, Suite 210, 495 Metro Place South, Dublin, OH, 43017-5319, US

(21) Appl. No.: 10/571,380

(22) PCT Filed: Sep. 13, 2004
(86) PCT No.: PCT/GB04/50008

§ 371 Date: Mar. 10, 2006

(30) Foreign Application Priority Data
Sep. 11, 2003 (GB) 0321335.2

(51) Int. Cl. H04L 9/00

(52) U.S. Cl. 726/1

(57) ABSTRACT

A security system for securing data paths in a network responds to events to change parameters of the security features in use. For example, it can change the type of encryption algorithm being used, or parameters of the encryption algorithm such as the key length or number of rounds of negotiation, or it can change a data transfer protocol. Events which the security system can respond to include user action, such as logging on to a more expensive service or moving their network location, or date or time, or patterns of usage in the network. The system processes incoming data using rules to determine a response. Parameters are changed by outputting configuration data to communication devices attached to the network, such as the head end and television receivers in a digital television system. In a preferred form of the system, the parameters of the security features in use can be dependent on network location, introducing diversity to the system which makes the security more difficult to penetrate.

The present invention relates to methods and apparatus for use in security. It finds particular application in securing communications between networked devices or systems.

Devices that communicate on networks commonly use cryptographic algorithms and special protocols to provide secure and integral transfer for data between those devices. A typical example is where a user uses a web browser to communicate with a bank's server to operate a banking account. In this case, it is typical to use a secure socket layer (SSL) protocol to create a secure data communication path between the browser device and the bank's server.

In an SSL protocol, at the time of establishing a connection for transferring data from the server to the browser, the server sends the browser its public encryption key. The browser (or the client it represents) generates a master key and sends it to the server using the public encryption key it has just received. Subsequent communication takes place using keys derived from the master key.

A major problem in secure networked communications is that third parties may try to determine what security system is in place and attempt to discover the data being communicated over a secure path. There are many examples in the art of such attacks being made on networks such as the Internet.

A common approach to dealing with attacks is to use algorithms and/or protocols to protect the data path which are ever more complex and difficult to attack. Examples are 1024-bit encryption algorithms and public key protocols. Although a security system of this sort is usually pre-configured, another approach is to negotiate parameters such as the encryption algorithm or the keys to be used, between parties at the time of connection, on a one-to-one basis.

An example of a technology which relies on security systems for information transfer is the digital TV market, particularly systems such as “Pay-per-View”. A known approach to limiting service access to authorised users only is to distribute a service encryption key to the authorised users by public key encryption. Subsequently, the service encryption key is used to send control words for the authorised users' descramblers in order to descramble the broadcast service. Alternatively, instead of control words, “zero knowledge” algorithms can be used.

In such systems, the service key again has to be distributed on a one-to-one basis, although the service key is then the same across the broadcast system for the relevant service.

According to a first aspect of the present invention, there is provided a security system for use in secure transfer of data to or from communication devices connected to a network, the system comprising:
i) an input for receiving data;
ii) security management apparatus for processing data received at the input and selecting a value for one or more parameters of the security system; and
iii) an output for use in identifying selected values to said communication devices,
   wherein the apparatus is adapted to process said received data to select said value(s), and to use said output to identify said value(s) to one or more of said communication devices for use in subsequent secure transfer of data to or from said one or more communication devices using the network.

The behaviour of such a security system in selecting the values can be designed to be random and/or responsive. Its behaviour depends for example on the way the apparatus is adapted to process the data and on the nature of the data being processed, in use of the system. Embodiments of the present invention can be used to implement random and/or dynamic changes in one or more parameters of the security system, and to give either a timed or a real time response to receipt of data. These characteristics can make unauthorised breach of the subsequent secure transfer of data significantly more difficult.

Embodiments of the invention thus provide a process for the dynamic implementation of security mechanisms that secure communications between networked systems. Importantly, embodiments of the present invention can respond to data received “on the fly”, while a system is already running. Thus the effect of identifying one or more value(s) to one or more of said communication devices can be to change a parameter already in use, not simply to install a parameter for use in subsequent secure transfer of data.

The way the apparatus is adapted to process the data to select the value(s) can generally be expressed in one or more rules, however such rules might be implemented. For instance, rules might be hard coded in the apparatus, decided randomly in real time or by a human operator, or stored in a database. Conveniently, the system further comprises a rules data store for storing one or more rules for use by the apparatus in processing received data to select said value(s). Such rules can be updated or changed if necessary.

The data received at the input for processing might arise from one or more different sources. For example, it might be produced by human intervention, by a clock or calendar, by an event such as a change in location of a user in relation to the network or a change in the device being used by a user, or by another data processing system which is monitoring for example a history of user actions or of previous behaviour of the security system, or by any combination of these. The security management system may also use data in addition to data received at the input in selecting a value, such as data separately available to it.

Parameters of the security system for which one or more values might be selected include for example cryptographic and computational algorithms, data transfer protocols and the configuration of these algorithms and protocols.

The identification of a value to one or more communication devices might be done by sending a signal comprising the value itself, encrypted or otherwise, or it might be done by sending an identifier for the value, or indeed for a package of values, which a communication device is adapted to interpret, for example by reference to a lookup table.

It is not essential that the security management apparatus is connected to the network to which the communication devices are connected. The input and output might be connected to one or more other communication systems. It is only essential that the output can be used in identifying selected values to the communication devices to configure the devices for subsequent transfer of data on the network, using the selected values. For example, the output and the communication devices might be connected to the Internet while the subsequent secure transfer of data occurs on a cable television network.

Parameters for which a value might be identified include:
Protocols, such as key transfer protocols
Cryptographic algorithms
Keys & Key lengths
Block lengths in block ciphers
Keyless “zero-knowledge” methods
Diverse code implementation

Values for such parameters might be at a high or a low level. That is, alternative values for one parameter might indicate that the whole parameter should be changed, for example one algorithm substituted for another, or just that the parameter should operate differently. For example, values for an “algorithm” parameter might indicate firstly that an AES (Advanced Encryption Standard) algorithm should be used and secondly that an RC4 (another known encryption algorithm) should be used. Alternatively, different values for an “algorithm” parameter might simply tune the algorithm, for example by setting the number of iterations used in a block cipher.

Another example of a cryptographic algorithm for which more than one value can be set is a master encryption algorithm. From one master algorithm, it is possible to generate many thousands of derivatives, each one as difficult to hack as the next. Values in this case might operate to select the derivative used.

Diverse code implementation is mentioned above as a parameter for which a value can be selected. This is a security technique in which the code present on computing apparatus to implement an algorithm is different from case to case. Although the algorithm will produce the same result, the actual code which a hacker would see during operation of the algorithm may be very different in one case from the next.

Although referred to as rules, a “rule” in the context of embodiments of the invention is not intended to have a special meaning but merely to provide an operation the security management apparatus can use to process received data and select a value for the one or more parameters. The received data might itself provide one or more values, or identifiers for values, to be selected In this case, the “rule” would operate so that the apparatus simply extracts and outputs the one or more values, or identifiers, appropriately. Alternatively, a rule might take multiple decision criteria into account before enabling the apparatus to select a value, such as time of day, network location of one or more communication devices, network activity such as content access or subscription payment, identity data for a user, and/or historical patterns of activity.

Rules can be implemented in different ways and might for example be expressed as constraint-based programming or an expert system. However, simple logic may also be appropriate, such as “If (condition A), then (Values X,Y)”.

Communication devices connected to the network in an embodiment of the invention might comprise transmitters and/or receivers of secure data, in use. The security system might itself be connected to the network on which the secure transfer of data is intended but it is not essential. It might instead use another route to deliver values, or identifiers for values, to communication devices.

Embodiments of the invention can provide secure transfer of data to or from communication devices connected to a network. Preferably, at least one rule stored in the rules data store comprises network location data such that a value for a parameter selected by the security management apparatus is at least partially network location dependent. Such network location data might for example identify a subnetwork served by the security management apparatus, or it might be specific to one or more communication devices connected to the network served by the security management apparatus. This enables the security management apparatus to set different values for different data paths in the network. Thus if one data path is compromised, others in the network are not immediately compromised in the same way.

This network location dependency can give the security management apparatus great flexibility. For example, in a digital television network, it becomes possible to set different values for parameters of a security system for use in data transfer to individual communication devices at the same geographic location, such as different set-top boxes in the same house. At this level, the network location data comprised by a rule would be the network address of one or more individual communication devices.

According to a second aspect of the present invention, there is provided a security system for use in secure transfer of data to or from communication devices connected to a network, the system comprising:
i) security management apparatus for selecting a value for one or more parameters of the security system; and
ii) an output for use in identifying selected values to said communication devices,
   wherein the apparatus is adapted to use one or more rules select said value(s), and to use said output to identify the selected value(s) to one or more of said communication devices for use in subsequent secure transfer of data to or from said one or more communication devices using the network, at least one of said one or more rules, in use of the system, comprising network location data and the apparatus is thus adapted to select a value which is at least partially network location dependent.

Such an arrangement gives the security system the powerful capability of diversity within a network. That is, it can set values for parameters of the security system which are different for different locations in the network. This again limits the extent to which the security of data transfer can be breached. The network location data might for example comprise data identifying a subnetwork of the network, or network addresses for one or more of the communication devices.

As in embodiments of the present invention in its first aspect, it is convenient that the system further comprises a rules data store for storing said one or more rules for use by the apparatus in processing received data to select said value(s).

Preferably, embodiments according to the second aspect of the present invention include one or more features of embodiments according to the first aspect of the present invention. For example, in particular, an embodiment according to the second aspect of the invention might further include an input for receiving data, the security management apparatus being adapted to select a value for one or more parameters of the security system in accordance with received data. This can give the security system the powerful combination of a dynamic response together with the diversity within a network mentioned above.

A useful component of a security system according to an embodiment of the present invention is an activity monitor for monitoring data arising in use of the system. At least one of the rules for selecting values may be arranged to operate such that a selected value is at least partially dependent on monitored data. This allows the security system to respond to activity which would not lead to a response in other circumstances. For example, access by a user at a new network location might not lead to a response on the first occasion but might if repeated more than a predetermined number of times in a set time interval. Examples of data which might be monitored in this way include network location data, values selected by the system and user identification data.

In an alternative arrangement, an activity monitor as described above might be provided as part of a communication device for use with the security system, rather than within the security system as described above. A novel and inventive communication device, for use with a security system as described above, therefore comprises an activity monitor for monitoring network activity by at least one other communication device and making monitored activity available to the security system for use in the selection of values.

It might be noted that the communication devices are effectively the transmitters and receivers of a communication system, in use, and can thus be viewed as related aspects of the same inventive concept.

Whether or not it comprises an activity monitor a communication device for use with the security system, the device being configurable to implement one or more selected values for one or more parameters of the security system, preferably comprises a values data store for storing a relationship between values for said one or more parameters and identifiers for the values, such that the device is configurable on receipt of one or more identifiers. This allows the device to be configured without actual values having to be transmitted to the device, but only identifiers for values.

According to a third aspect of the present invention, there is provided a method of protecting transfer of data between communication devices attached to a network, using one or more security parameters to protect said transfer of data, the one or more security parameters having selectable values, which method comprises the steps of:

i) receiving stimulus data;

ii) accessing current data identified in a set of one or more decision criteria;

iii) processing the stimulus data together with said current data to select at least one value of at least one of said security parameter(s); and

iv) outputting a signal to two or more of the communication devices, the signal comprising the at least one selected value.

Stimulus data might be received from the network to which the communication devices are attached, or from a different network.

Methods according to this third aspect of the present invention may further comprise the step of monitoring activity in relation to the protected transfer of data on the network in order to provide said current data. Such methods may also or alternatively comprise the step of processing the current data prior to processing the stimulus data. This allows patterns of behaviour in relation to the protected transfer of data on the network to be taken into account, such as usage over time or geographic clustering.

A security system according to an embodiment of the present invention will now be described, by way of example only, with reference to the following figures in which:

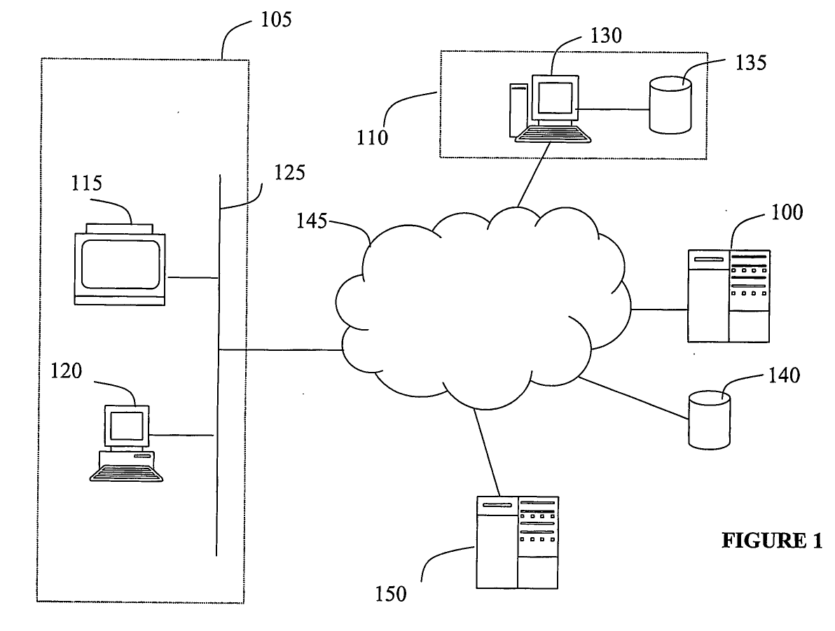

FIG. 1 shows a functional block diagram of the security system connected to a network to control security parameters applied to data paths in the network;

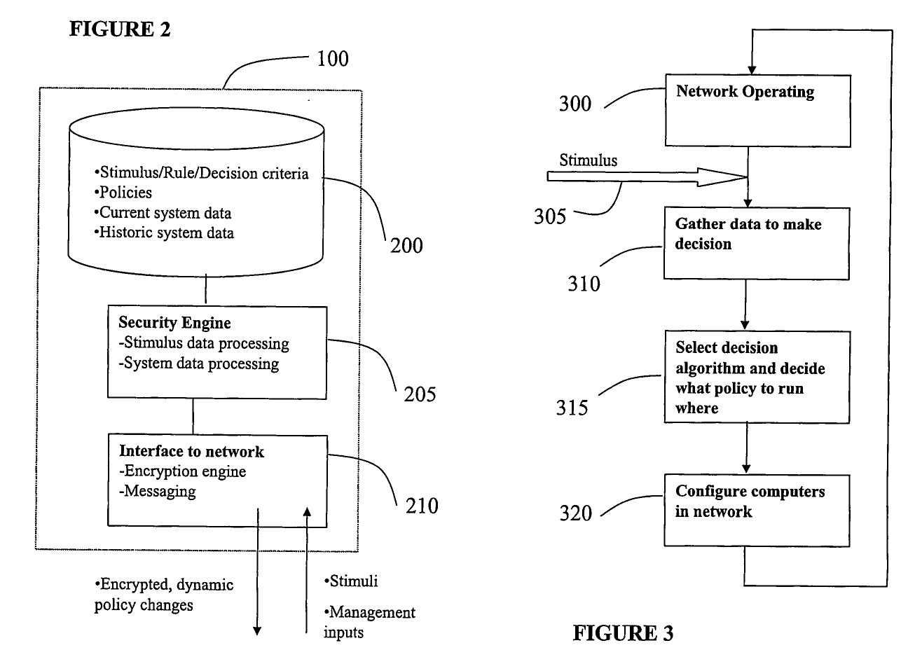

FIG. 2 shows a functional block diagram of a security engine for use in the security system of FIG. 1;

FIG. 3 shows a flow diagram of operation of the security engine in use;

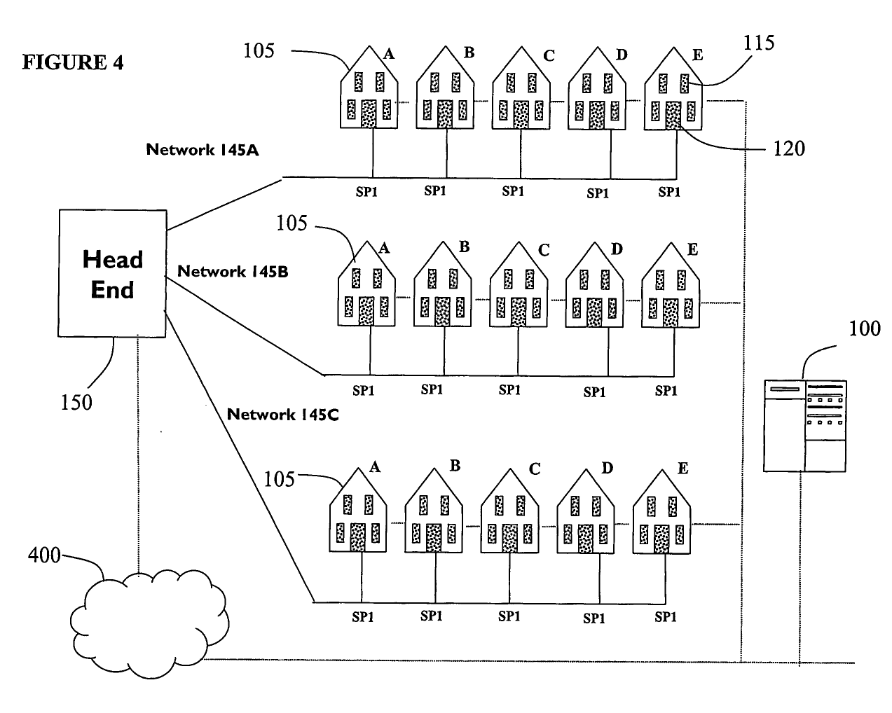

FIGS. 4 to 8 show network diversity in packages of security values which can be applied by the security engine in use; and

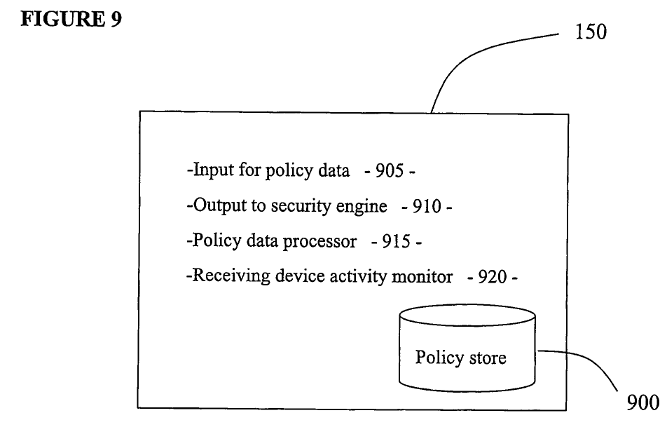

FIG. 9 shows a functional block diagram of a communication device for use in the security system of FIG. 1.

### 1. NETWORK OVERVIEW

Referring to FIG. 1, the overall role of the security system is to protect data paths between communication devices 115, 120, 150 connected to a network 145. In the embodiment described here, the communication devices comprise a “publishing” device 150 and at least two receiving devices, such as a personal computer 120 and a television with a set-top box 115 installed at domestic premises 105. (As shown in FIG. 1, the receiving devices 115, 120 are connected to the same sub-network 125 but this is not essential.)

The security system primarily comprises a software process running on computing platform to provide a security engine 100 connected to the communication devices 115, 120, 150. The way in which the security system protects the data paths between the communication devices 115, 120, 150 is to select a package of values for various security parameters, such as encryption keys, algorithms and protocols, and to instruct the publishing device 150 and its receiving devices 115, 120 to use the package for secure communication between them. The security engine 100 can change the package in force at any time, on a dynamic basis.

The security engine 100 can make these changes based on data received in real-time, and on other criteria, using a rule-based approach. Clearly it can improve the strength of the security if the packages in force at any time are not predictable, and these are further discussed below, under the heading “2. Security Engine”.

Each package of values available to the security system is referred to hereinafter as a “policy”. A single policy, such as “Policy SP1”, thus represents a set of one or more specific algorithms, protocols, configuration and/or other parameter values. The policies available to the security engine 100 for selection are stored in the database 140.

Different data paths in the network 145 can have different policies in force at any time. The security engine 100 implements that by selecting the sets of communication devices 115, 120, 150 for instruction to use the same policy, for example because of their individual network locations or by sub-network, or by any other appropriate means.

A manager's domain 110 allows the security engine 100 to be controlled by a security operator, for example for original setup, updates and modification, and a separate database 140 is accessible to both the manager's domain 110 and the security engine 100.

An operator using the manager's domain 110 can determine the range of decisions that the security engine 100 can take, such as selecting a number of protocols and setting which parameters of those protocols can be changed, and selecting sets of communication devices which are to be treated as sub-networks, but thereafter the security engine 100 dictates the selection, implementation and configuration of protocols and algorithms used in securing data transfer between the communication devices 115, 120, 150 and the communication devices 115, 120, 150 have no part in the decision except to implement it “on command”.

It will be understood that the arrangement shown in FIG. 1 is not essential, the location of software processes and data being a question of design and circumstance. For example, it might well be the case that the manager's domain 110, the security engine 100 and the database 140 are all co-located on the same server or other computing platform. Further, although the security engine 100 is shown as connected to the same network 145 as the one to be protected, this is not essential. It is only essential that the security engine 100 should be able to communicate with the publishing and receiving communication devices 115, 120, 150 and this might be done over a separate network, as shown in FIG. 4.

### 2. SECURITY ENGINE

Referring to FIG. 2, the security engine 100 decides which security policy should be in effect at any one time and place in the network by applying rules in the light of decision criteria. Decisions are triggered by stimuli and the security engine 100 has an interface 210 to the network 145 which can receive stimuli via the network, either as operator inputs from the manager's domain 110 or from elsewhere.

The stimuli, decision criteria and rules are each described in more detail below, followed by the policies which the security engine 100 might have available for selection. As shown in FIG. 2, they might be stored in data storage 200 co-located with the security engine 100 or might be available remotely, in the data store 140 or the manager's domain 110. However, for security reasons it may be preferred that they are stored in local data storage 200.

### 2.1 Stimuli

The security engine 100 can be triggered to make decisions as to which policy should be in use by a number of stimuli. These can include for example any one or more of the following:
Interactions between the communication devices 115, 120, 150, for instance between a publishing device 150 and a receiving device 115, 120
Interactions between any of the communication devices 115, 120, 150 and another entity, which might comprise another process in a communication device 115, 120, 150 or any other entity connected to the network.
Time of day
Human intervention
Scheduled policy changes

These stimuli might be received over the network 145, via the interface 210, or might be internal to the security engine 100. For example, the scheduled policy changes and those based on time of day might arise from a clock process within or associated with the security engine 100. Human intervention might be made by an operator from the manager's domain 110.

Stimuli arising from interaction between communication devices 115, 120, 150, or between communication devices 115, 120, 150 and other entities, will usually be communicated by one or more of the communication devices to the security engine 100 and may therefore be received via the interface 210.

Interactions which might arise as stimuli could stem from user activity at a receiving device 115, 120 for example. A user logging onto the system may supply a user ID and password for authentication and the authenticated ID might be passed to the security engine 100 as a stimulus to provide a fresh security policy for a data path between that user's receiving device and the supplier domain for a service the user has accessed. Alternatively, the user might have used a communication device to set up a data path for downloading data having a high security rating, or to pay a subscription. Either of these might equally be reported by the communication device to the security engine 100 as a stimulus to install a fresh policy on a specified data path.

### 2.2 Decision Criteria

Once a stimulus has arisen, the security engine 100 may take any of several decision criteria into account in installing a fresh policy on a data path. For example, the security policy engine might take into account any one or more of the following criteria:
1. Date Time of day
2. Identity of publisher or consumer
3. Action being performed by the publisher or consumer, such as content access or paying subscription
4. Location of publisher or consumer logically or physically in the network
5. Device being used
6. Parameters set by the network operator
7. Subscription status between consumer/publisher or end-user/network operator
8. History associated with any one or more of the above
9. History of policies previously applied

As mentioned above, some of these such as “Action being performed by the publisher or consumer” might arise as a stimulus in the form of a report from a communication device 115, 120, 150. Some might be available from other processes. For example, subscription status would usually be available from a subscription monitoring service. However, the security engine 100 can also be designed to perform ongoing data processing so as to track aspects not otherwise available. For example, the history of policies previously applied is unlikely to be monitored by another process.

### 2.3 Rules

Once the security engine 100 has been triggered to make a decision, it refers to rules in processing the decision criteria to arrive at a new security policy. Different deployments and implementations of the security engine can make use of different rules and apply different decision criteria to select the rules. However, examples of rules are as follows:
R1: IF
   Conditions A, B and D are met
   THEN
   On Tuesdays, run policy SP1 in Manchester, SP2 in London and SP2 everywhere else;
R2: IF
   Conditions B and E are met
   THEN

On Wednesdays, run all the odd house numbers on SP1 and all the even house numbers on SP2, except those which watch channel 17 who will use SP5;
R3: IF
   Condition A is met
   THEN
   Unless rules R1 or R2 apply, use a random policy in random parts of the network.

It is noticeable that these rules are each location-dependent. This offers diversity within a network.

¹The rules as written above are written to show their effect in the real world. In practice, the rules are more likely to be written in terms of network locations. For example, Manchester and London would be identified to the security engine 100 as sub-networks and odd and even house numbers would be interpreted from subscriber records to give network addresses for specific communication devices 115, 120 registered at a common address.

Rules incorporating network location in this way mean that even individual set-top boxes in the same house can be assigned different security policies. Further, because the stimuli can include interactions between the communication devices 115, 120, 150, for instance between a publishing device 150 and a receiving device 115, 120, even individual sessions, or sessions involving specific individuals, can be assigned different policies.

The rules as written above incorporate conditions to be met before applying the rule. These conditions will usually be based on specified values for one or more of the decision criteria described above. The conditions and their usage are further described under the heading “3. Security Engine in Use”, below.

Preferably, the way in which the security engine 100 selects and/or implements policy changes is relatively unpredictable. This can be based for example on historic behaviour of the system, which is further discussed above, but another factor is the choice of rules applied. It is possible to include more than one rule that might apply in a given situation and for the security engine 100 to make random choices between rules.

### 2.4 Policies

Once the security engine 100 has applied a rule to decision criteria, it can select a policy which will be sent to relevant communication devices 115, 120, 150 for implementation. A policy can be described as the collection of all those parameters, including methods, means and protocols and their configuration, for exchanging data between systems on a network. That is, it is everything that makes communication between systems work—be it one-to-one, one-to-many, or many-to-one in nature.

Some parameters are more suitable or useful or better than others in that they are more immediately useful—e.g. changing key lengths or changing protocols is very effective in making a network resistant to attack. However, in designing a security engine 100, the choice of policies that will be available is very much down to choosing a set of policies that provide a diverse effect on security but are efficient in the use of network and computing bandwidth in devices attached to the network. For example, it is preferable to select a protocol that does not result in the network overloading with packets, or that does not rely on a low-latency path between endpoints. The overall idea is that if a hacker manages to break one of the policies, the others in use are diverse enough to prevent the first hack being used elsewhere or at a different time when a different policy is in effect.

A security policy can be a set of values for any one or more of the following:
Protocols, such as a random key protocol, and what configuration of protocol is to be used, such as DH (Diffie-Hellman) key exchange
Cryptographic algorithms, such as AES (Advanced Encryption Standard) and RC4 (a known encryption algorithm), and their configuration such as 128-bit or 1024-bit
The number of cycles that a particular algorithm uses to output encrypted data
Keys & Key lengths
Key transfer protocols
The period of time that a key is valid
Keyless “zero-knowledge” methods
Diverse code implementation

Examples of security policies are:
SP1: 128-bit AES 10 rounds
SP2: 1024-bit RC4 with random keys and DH key exchange

### 2.5 Delivering Values to Devices

Once a policy has been selected, it is necessary to implement it on a relevant data path. This can be done by the security engine 100 directly, by sending a policy identifier or actual values for a policy to the relevant communication devices 115, 120, 150 which respond by configuring themselves appropriately. Alternatively it can be done indirectly, by sending the identifier or values to configuration means (not shown) for the communication devices. The indirect method might be chosen for example where there are pre-existing configuration means for the communication devices 115, 120, 150. In either case, particularly if communication is already underway between the communication devices 115, 120, 150, it may be necessary to synchronise changes to separate devices.

Clearly it is important to ensure that the policy data is not intercepted during delivery to the communication devices 115, 120, 150. Where the security engine 100 is connected to the devices by the network 145 in which data paths are to be protected by an embodiment of the present invention, then a policy can be in place to protect the delivery of policy data to the devices or other location. However, the security engine 100 might be connected to the communication devices 115, 120, 150 by other means and known secure methods for protecting the policy data can be used.

### 3. SECURITY ENGINE IN USE

Referring to FIG. 3, a flow diagram for operation of the security engine 100 is as follows:

Step 300: the network is operating;

Step 305: a stimulus arrives, for example a new user ID is delivered by a communication device 115;

Step 310: the security engine 100 selects a rule appropriate to receipt of a new user ID and assembles data necessary to run the rule to select an appropriate policy, this being data such as the current network location for the communication device 115, the service requested, and the subscription status associated with the user ID;

Step 315: the security engine 100 runs the rule and selects one or more policies;

Step 320: the security engine 100 outputs the values dictated by the policy(ies) to configure the appropriate communication devices 115, 120, 150 and returns to Step 300 to await the next stimulus.

Referring to FIGS. 4 to 8, the effect of various policies with network location diversity is that the security policy in force can be network-wide or location specific even to the level of a specific communication device, such as one set-top box 115 in a domestic environment. A set of scenarios follows.

In the following, it might be noted that the range of policies that might be available to protect data paths in the network 145 may depend on the security product selected by the publisher. It is possible to have a set of security products in which cheaper products cover a smaller or simpler range of policies. In the following, security products are treated as providing different levels of security (“SL1”, “SL2” and so on). Each level of security supports up to a particular level of complexity

Referring to FIG. 4, a service such as a digital television service is distributed from a head end 150 to a set of sub-networks, 145A, 145B, and 145C. The head end thus constitutes a publishing communication device 150 and there are receiving communication devices 115, 120 at domestic premises 105, connected to the various sub-networks (only one example of each of the receiving communication devices 115, 120 is referenced in the Figure).

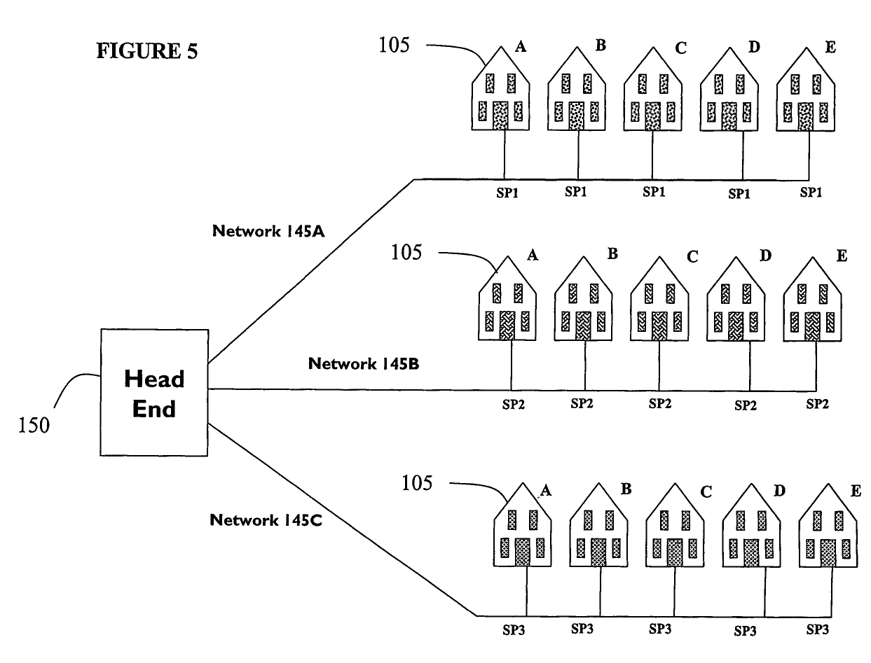

A security engine 100 is connected to the head end 150 and the domestic premises 105 via a different network 400 such as the Internet. (This is only shown in FIG. 4 but applies equally to the arrangements shown in FIGS. 5 to 8.)

At start-up of the service, the security policies in force across the sub-networks 145A, 145B, and 145C and for each of the receiving communication devices 115, 120 are the same. This is indicated in FIG. 4 by the pattern shown for all the receiving communication devices 115, 120.

Referring to FIG. 5, a new service is introduced which is for authorised viewers only. The head end 150 reports the new service, for instance “S3a”, to the security engine 100 which receives the report as a stimulus. The report might simply contain identifiers for the network and for the new service. The security engine 100 needs to select a rule appropriate to the new service stimulus and to assemble data necessary to run the rule and select and implement one or more appropriate policies. It therefore refers to a data store 200, 140, for instance a lookup table, to find which rule to run and to find out what items of data to assemble. The lookup table lists the new service (for example “S3a”) against a rule (for example R15) and the items of data. An entry in the lookup table might represent, for example:
“S3a: R15 (current security level on Networks 145A, 145B, and 145C, current security product held by publisher)”

The security engine 100 will therefore need to gather data in respect of the current security level of the policy in place on the networks 145A, 145B, and 145C, and the current security product paid for by the publisher. According to rule R15, the new service S3a may require a security level “SL5”. Having obtained the data, the engine 100 runs R15 which can be represented as follows:
“R15:
   IF
   current security levele=SL5
   or
   current security product held by publisher covers SL5
   THEN
   On each sub-network in turn run Policies SP1, SP2, SP3, SP4 . . . ”

To implement R15, the security engine 100 must configure the head end 150 and the communication devices on each sub-network 145A, 145B, and 145C to load the appropriate values according to the policy for each sub-network.

In order to respond to the stimulus as described above, the security engine 100 requires up to date network and product status data for the publisher. This can either be maintained by the security engine 100 or obtained on demand from the manager's domain 110.

It may be the case that the rule R15 doesn't run. For example, the publisher might not have purchased a product which includes SL5. Particularly in the latter case, the security engine 100 can return a message to the head end 150 notifying the situation.

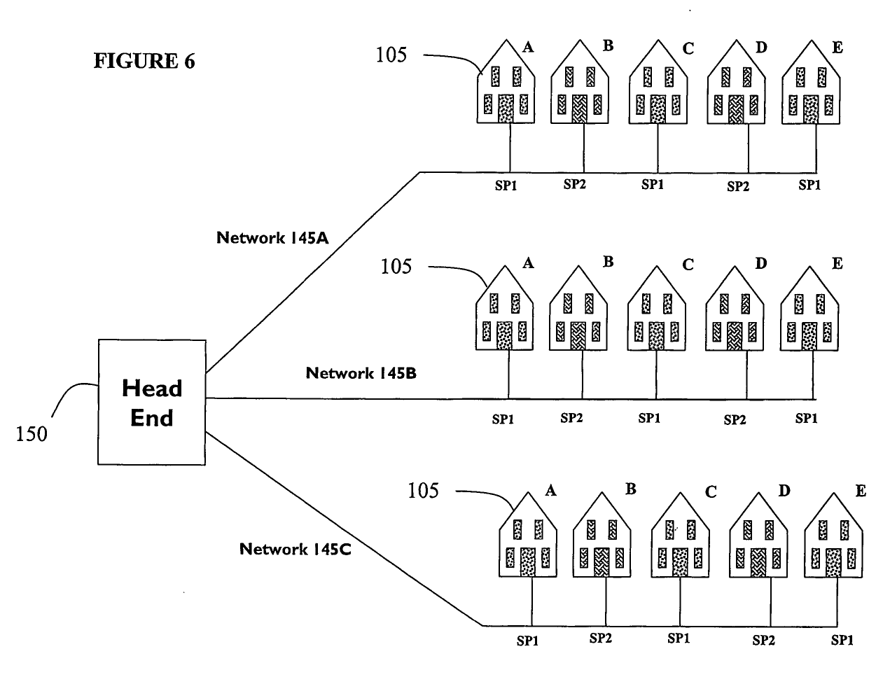

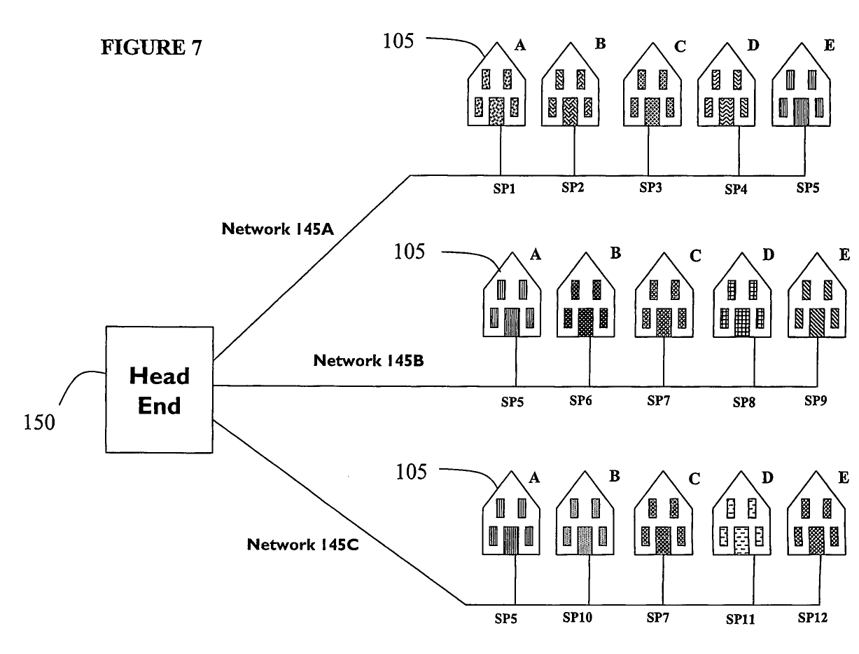

Referring to FIGS. 6 and 7, the scenario described in relation to FIG. 5 might lead to implementation of different security levels. In FIG. 6, different policies are implemented at alternate premises on each sub-network and in FIG. 7 the policies are randomly distributed across premises.

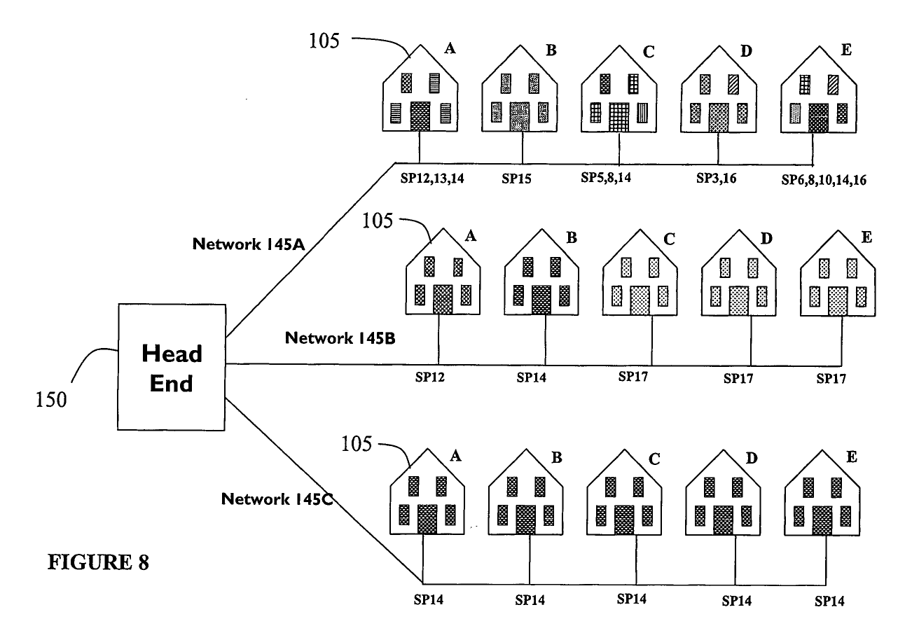

Referring to FIG. 8, a stimulus might arise at a user's communication device 115, 120 and the result might be as shown on sub-network A in FIG. 8. For example, at premises “D”, all the communication devices are running policy SP3 except for one device running policy SP16. This may have arisen when a user accessed a new service with a different security level. In this case, either the communication device at the premises “D” or the head end 150 could deliver a report as a stimulus to the security engine 100. The report could comprise for example a code for the new service (“S18”) plus a user ID (“U3981”) and a network address for the communication device (“NA369.09156”).

Again, the security engine 100 needs to select a rule appropriate to the new service stimulus and to assemble data necessary to run the rule and select and implement an appropriate policy. It therefore refers to the data store 200, 140 to find which rule to run and to find out what items of data to assemble. An entry for the new service S18 in the lookup table might represent, for example:
“S18: R36 (current security level in sub-network, current security product held by publisher, current policy for device network address, subscription status for user ID)”

Once the security engine 100 has assembled the data indicated, it can run R36. For example, R36 might be as follows:
“R36:
   IF
   [current security level in sub-network=SL21 OR current security product held by publisher covers SL21]
   current policy for device network address≠SP16
   current subscription status for user ID covers S18
   THEN
   To device network address, run SP16”

As long as the R36 criteria are met, values for the policy SP16 need to be configured at the head end 150 and the relevant communication device.

The security engine 100 can cause a policy to be implemented using a number of methods:
sending a message to the publishing and receiving communication devices 115, 120, 150 to indicate which policy should be used
Sending the values relevant to a policy to the publishing and receiving communication devices 115, 120, 150
Using a combination of the above methods

In one specific implementation, a security engine 100 is used to determine security policy in a network where digital television signals are being transmitted. The data transfer process between the head end 150 and receiving communication devices 115 is embedded in a digital television-scrambling device at the head end 150 and in a descrambler of the digital television receiver at the receiving device 115. The head end 150 and receiving communication devices 115 are connected to a network 145A, 145B, and 145C where bi-directional communications are possible even if different technologies are used to implement the data communications path in each direction.

The security engine 100 is loaded with rules that determine which security policy is in force at any moment. The engine 100 loads security policies into the data transfer process via a network data transfer path. When a decision point (i.e. a point in time where a decision about which security policy should be in use) is reached, the security engine 100 consults its rules, as described above, to determine which policy shall be used. Once a decision is made, the security engine 100 implements the policy by loading the policy data from the security policy store 200 into the data transfer process at the head end 150 and at the receiving communication devices 115. Where the security engine 100 is aware that a particular policy is already loaded, this step is omitted. Once the security policy is available for use in the data transfer process, the security engine 100 activates the policy by sending a message to the data transfer process. At a suitable and convenient point in time, the head end 150 and receiving communication devices 115 then switch to using the new security policy.

### 4. RESPONSE TO NETWORK ACTIVITY

As mentioned above, once a stimulus has arisen, the security engine 100 may take any of several decision criteria into account in installing a fresh policy on a data path. A potential set of criteria are listed above under the heading “2.2 Decision Criteria” and include the history associated with decision criteria in use of the system and the history of policy selection in use of the system.

Referring to FIG. 2, the security engine 100 is provided with a data store 200 for storing, amongst other things, historic system data. This might include for example data associated with decision criteria in use of the system, and/or policy selection data.

An example of a response by the security engine 100 to the history of data associated with decision criteria would be a rule which stated:
“R98:
   IF
   [current security level in sub-network=SL43 OR current security product held by publisher covers SL43]
   current policy for device network address≠SP18
   current subscription status for user ID covers (relevant service)
   new network location for user ID has been repeated six times in five working days
   THEN
   To device network address, run SP18”

Such a rule would have the effect that if a user starts to use a device in a new location regularly, then the security level protecting the data path to that new location is automatically upgraded.

An example of a response by the security engine 100 to the history of data associated with policy selection would be a rule which stated:
“R83:
   IF
   proposed new policy for device network address=SP17
   proposed new policy has already been selected for five other device network addresses on same sub-network
   THEN
   To device network address, run a policy randomly selected from the group SP35 to SP40”

Such a rule might be run after a new policy for a network address has been selected but not implemented. It would have the effect that if the same policy were already in place to several other devices on the same sub-network, then a policy from a different group of policies should be used.

### 5. COMMUNICATION DEVICES 115, 120, 150

Referring to FIG. 9, the communication devices 115, 120, 150 are generally of known type. However, there are novel features which may be provided in order to implement an embodiment of the present invention. For example, in order for the security engine 100 to respond to activity at the communication devices, it is necessary for the activity to be reported to the security engine 100. It might be convenient for a publishing device 150, such as the head end of a digital television system, to be adapted to notify the security engine 100 of relevant activity. The publishing device 150 might therefore comprise a monitor 920 for monitoring communications from receiving devices 115, 120 for relevant data, such as a request incorporating a new user ID (identifier) or a new network location for a current user ID. Either any relevant data detected by the monitor 920 is copied to an output 910 to the security engine 100, or accumulated or processed data is used. This allows network activity at the communication devices which might not normally be treated as a stimulus for the security engine 100 to be so treated. For example, isolated requests by a user from different network locations might not be treated as a stimulus whereas multiple requests by a user from one new network location might be treated as a stimulus. The monitor 920 can be used in making this distinction.

To implement a change in the security policy in operation for a data path in the network 145, a possible arrangement is for the publishing device 150 to receive the policy data from the security engine 100 and to use existing configuration mechanisms to configure receiving devices 115, 120 appropriately. Security is improved if the security engine 100 sends code for the policy or policies to be implemented and the publishing device 150 has access to a policy data store 900 for use in translating the code to actual values for configuration purposes. Alternatively, the receiving devices 115, 120 might have access to a policy data store 900 so that the actual values never have to be transmitted on any part of a network 125, 145, 400 except potentially at installation or update.

In this specification, the word “comprising” is intended to be broadly interpreted so as to include for instance at least the meaning of either of the following phrases: “consisting solely of” and “including amongst other things”.

It will be understood that embodiments of the present invention may be supported by platform of various types and configurations. The presence of the platform is not essential to an embodiment of the invention. An embodiment of the present invention might therefore comprise software recorded on one or more data carriers, or embodied as a signal, for loading onto suitable platform for use.

1. A security system for use in secure transfer of data to or from communication devices connected to a network, the system comprising:
i) an input for receiving data;
ii) security management apparatus for processing data received at the input and selecting a value for one or more parameters of the security system; and
iii) an output for use in identifying selected values to said communication devices,
wherein the apparatus is adapted to process said received data to select said value(s), and to use said output to identify said value(s) to one or more of said communication devices for use in subsequent secure transfer of data to or from said one or more communication devices using the network.

2. A security system according to claim 1 wherein the apparatus is adapted to process said received data to select said value(s) by using one or more rules.

3. A security system according to claim 2, the system further comprising a rules data store for storing said one or more rules.

4. A security system according to any one of the preceding claims wherein at least one of the input and the output is connected to a communication path which is separate from the network.

5. A security system according to any one of the preceding claims wherein the input is connected to at least one of said communication devices, in use of the system, for receiving data to be processed, such that the apparatus is adapted to select at least one value which is at least partially dependent on data received from a said communication device.

6. A security system according to any one of the preceding claims wherein the input is connected to data processing apparatus for processing data associated with use of the network, such that the apparatus is adapted to select at least one value which is at least partially dependent on network usage data.

7. A security system according to any one of the preceding claims, wherein said one or more parameters for which one or more values might be selected comprise one or more parameters of an encryption algorithm.

8. A security system according to claim 7 wherein said one or more parameters comprise a type of encryption algorithm selected from two or more different types of encryption algorithms available to the system.

9. A security system according to claim 7 wherein the encryption algorithm comprises a master encryption algorithm and said one or more parameters comprise an encryption algorithm selected from two or more different encryption algorithms derivable from the master encryption algorithm.

10. A security system according to any one of the preceding claims wherein said one or more parameters comprise an encryption key exchange protocol selected from two or more different types of encryption key exchange protocol available to the system.

11. A security system according to any one of the preceding claims wherein said one or more parameters comprise a parameter of an encryption key exchange protocol.

12. A security system according to claim 11 wherein said parameter of an encryption key exchange protocol comprises a number of rounds used in the encryption key exchange protocol.

13. A security system according to any one of the preceding claims wherein said one or more parameters comprise a data transfer protocol selected from two or more different types of data transfer protocol available to the system.

14. A security system according to any one of the preceding claims wherein said one or more parameters comprise a parameter of a data transfer protocol.

15. A security system according to any one of the preceding claims wherein the system is arranged to use said output to identify said value(s) to one or more of said communication devices by sending a signal comprising the value(s).

16. A security system according to any one of the preceding claims wherein the system is arranged to use said output to identify said value(s) to one or more of said communication devices by sending a signal comprising identifier(s) for the value(s).

17. A security system according to any one of the preceding claims wherein the system is arranged to use said output to identify said value(s) to one or more of said communication devices by sending a signal comprising an identifier for a set of two or more value(s).

18. A security system according to any one of the preceding claims wherein at least one of said rules comprises network location data such that the system is adapted to identify values to one or more communication devices which values are at least partially network location dependent.

19. A security system according to claim 18 wherein the network location data comprises the network location of at least one communication device in the network.

20. A security system according to claim 18 wherein the network location data identifies a sub-network of the network.

21. A security system according to any one of the preceding claims wherein at least one of said rules comprises time and/or date data such that the system is adapted to identify values to one or more communication devices which values are at least partially dependent on time and/or date.

22. A security system for use in secure transfer of data to or from communication devices connected to a network, the system comprising:
i) security management apparatus for selecting a value for one or more parameters of the security system; and
ii) an output for use in identifying selected values to said communication devices, wherein the apparatus is adapted to use one or more rules to select said value(s), and to use said output to identify the selected value(s) to one or more of said communication devices for use in subsequent secure transfer of data to or from said one or more communication devices using the network, at least one of said one or more rules, in use of the system, comprising network location data and the apparatus is thus adapted to select a value which is at least partially network location dependent.

23. A security system according to claim 22 wherein the network location data comprises the network location of at least one communication device in the network.

24. A security system according to claim 22 wherein the network location data identifies a sub-network of the network.

25. A security system according to any one of claims 22 to 24 wherein at least one of said rules comprises data in addition to network location data and the apparatus is thus adapted to select at least one value which is only partially network location dependent.

26. A security system according to claim 25 wherein said data in addition to network location data comprises time and/or date data.

27. A security system according to any one of the preceding claims, further comprising an activity monitor for monitoring data arising in use of the system, and at least one of said rules for selecting values is arranged to operate such that a selected value is at least partially dependent on monitored data.

28. A security system according to claim 27 wherein the monitored data comprises network location data.

29. A security system according to either one of claims 27 or 28 wherein the monitored data comprises values selected.

30. A security system according to any one of claims 27 to 29 wherein the monitored data comprises user identification data.

31. A communication device for use with a security system according to any one of the preceding claims, the device being configurable to implement one or more selected values for one or more parameters of the security system, said device comprising a values data store for storing a relationship between values for said one or more parameters and identifiers for the values, such that the device is configurable on receipt of one or more identifiers.

32. A communication device for use with a security system according to any one of the preceding claims, the device comprising an activity monitor for monitoring network activity by at least one other communication device and making monitored activity available to the security system for use in the selection of values.

33. A method of protecting transfer of data between communication devices attached to a network using one or more security parameters to protect said transfer of data, the one or more security parameters having selectable values, which method comprises the steps of:
i) receiving stimulus data;
ii) accessing current data identified in a set of one or more decision criteria;
iii) processing the stimulus data together with said current data to select at least one value of at least one of said security parameter(s); and
iv) outputting a signal to two or more of the communication devices, the signal comprising the at least one selected value.

34. A method according to claim 33, further comprising the step of monitoring activity in relation to the protected transfer of data on the network in order to provide said current data.

35. A method according to either one of claims 33 or 34, further comprising the step of processing the current data prior to processing the stimulus data.
